(19) United States
(12) Patent Application Publication
(10) Pub. No.: US 2014/0365387 A1
(43) Pub. Date: Dec. 11, 2014

(54) ONLINE SYSTEM & PORTAL TO FACILITATE REAL ESTATE TRANSACTION

(71) Applicants: George Kiaman, Burbank, CA (US); Michael Kiaman, Burbank, CA (US)

(72) Inventors: George Kiaman, Burbank, CA (US); Michael Kiaman, Burbank, CA (US)

(21) Appl. No.: 14/295,070

(22) Filed: Jun. 3, 2014

Related U.S. Application Data
(60) Provisional application No. 61/831,414, filed on Jun. 5, 2013.

(51) Int. Cl. G06Q 50/16; G06Q 30/06

(52) U.S. Cl. CPC G06Q 50/16; G06Q 30/06
USPC 705/313

(57) ABSTRACT

The disclosure describes systems, methods and devices relating to various configurations of a real estate system or portal which allows buyers or buyer agents to browse properties, request and provide lender pre-approvals, and place offers on properties. The system may also allow for lenders to manage pre-approvals and for sellers or seller agents to receive and manage offers. The system may also allow for facilitation of exchanges of documents and the escrow process.

This application claims priority to U.S. Provisional Patent No. 61/831,414, to Kiaman et al., filed on Jun. 5, 2013, and entitled “ONLINE PORTAL. TO FACILITATE REAL ESTATE TRANSACTION.”

### BACKGROUND OF THE INVENTION

1. Field of the Invention

The invention relates generally to methods and systems for facilitating and streamlining real estate transactions on a portal. Specifically providing a system to create or qualify and provide service to qualified buyers.

2. Description of the Related Art

The current market for real estate transactions is in large part immersed by Multiple Listing Services (MLS) platforms and other web portals that offer property listing information. MLS focuses on its licensing relationship with the largest real estate salesperson organization, which allows real estate salespersons and brokers who pay a membership fee through the National Association of Realtors (NAR) for access. Real Estate salespersons as defined by this document will refer to individuals who engage in the process of selling or leasing real estate property on behalf of buyers and lessees of a property, or sellers or lessors of the property. MLS platforms allow real estate salespersons and brokers, designated as “Realtors” by the NAR, to search and list properties for sale online. The MLS platform allows the general public to conduct a limited search for properties listed on their websites, providing general property information, but usually limiting access from more in-depth details about the property. Realtors are provided full access and are usually able to attain much more detailed information, including but not limited to; tax information, property owner information and details on how to place an offer for the home. These MLS platforms do not allow offers for the property to be placed directly through their portal. Interested Realtors for a particular property are provided forms to download, which are usually either faxed or emailed to the listing Realtors, depending on how they would like an offer to be received.

As indicated in FIG. 1, in step 110 a buyer begins working with an agent. Next, in step 120, a buyer is referred to a lender to get a pre-approval for a loan. Next, in step 130, interested buyers working with licensed Realtors choose a property of interest. Upon choosing this property, in step 140, the Realtor utilizes the MLS or other programs to view the details of a property 150 and attain information on how to place an offer. After this process, the Realtor then downloads the necessary offer contract and either completes and signs the contract freehand or through an e-signature. After this process, the Realtor can then fax 160 (if completed freehand), or email 170 the offer sheet (if using the e-signature or scanning the document) through a separate email account or fax machine device. The MLS and other platforms in the market do not have a streamlined and integrated point of action that allows interested buyers to place an offer directly through the site when viewing the property details.

Amongst other web platforms available, an entity such as homepath.com allows licensed real estate salespersons to place offers on foreclosed homes only through their online portal. This portal is limited to licensed representatives only, and focuses on an offer placement on foreclosed homes only. As indicated directly on their site, “All offers for HomePath properties must be submitted through a licensed real estate broker/agent. You may select a licensed real estate broker/agent of your choosing.” The process of using homepath.com or similar systems is depicted in FIG. 2. As described, in step 210 a buyer begins working with an agent and is then referred to a lender to become pre-approved in step 220. Following the referral, the buyer works with the agent to find a foreclosed home in step 230. Next, using Homepath.com 240, the listing and property details are procured 250 and an offer may be placed on the foreclosed home 260. This portal limits the use from the general public, allowing only licensed real estate salespersons and on foreclosed homes. Furthermore, the HomePath process relies on the funding requirements being addressed by the real estate salesperson. This assumption lends itself to potential problems that are inherent to the industry. This particular problem is making sure a buyer is qualified. This process usually requires a third party lender to provide a pre-approval that qualifies the buyer as a legitimate buyer and consequently makes the buyer's offer a legitimate offer.

More often than not, any buyer or Realtor representing a buyer who intends to finance some or all of the purchase funding is required to acquire what is known as “pre-approval” from a lender. A “pre-approval” utilizes a buyer's financial information to determine a buyer's ability to pay and in turn, how much the lender would be willing to loan the buyer to make the purchase. As the name indicates, a “pre-approval” is not a final approval from the lender, and is subject to further variables and verification once an offer for a home is accepted by a listing agent and escrow for the transfer of title to the property is started. While the sales process demands this component to verify affordability, the current market offering for online real estate offers (i.e. HomePath.com) does not include providing a pre-approval prior to placing the offer, which means potential buyers may not be qualified. These sites offer a format similar to an auction, where bids on a property may be placed, but the listing agent or seller does not know the buyer's purchasing power, which clouds the quality of an offer for a seller using these portals because the offers are less substantive without lender pre-approval. The lender pre-approval assumes a buyer to be a “Qualified Buyer.”

The problem with the current platforms available to home buyers and home buyer representatives is the multiple steps involved in placing an offer on a property of interest making the process long and inefficient. The current platforms for placing an offer for a listing requires individuals to (1) download appropriate documents, (2) complete them, and (3) either fax them to the listing agent or email them to the listing agent via their own personal or professional email accounts. These steps are undertaken usually after a buyer has been pre-approved by a loan officer. This process lends itself to several inefficiencies including additional steps and timing. The current environment requires a usage of disparate fax, emails and forms in order to conduct the action of placing an offer. It is desirable to provide a solution with all these portions integrated.

### SUMMARY OF THE INVENTION

The present invention is directed to various configurations of a real estate system or portal which allows buyers or buyer agents to browse properties, request and provide lender pre-approvals, and place offers on properties. The system may also allow for lenders to manage pre-approvals and for sellers or seller agents to receive and manage offers. The system may also allow for facilitation of the escrow process.

One aspect of the present disclosure provides a method of facilitating real estate transactions through a portal, comprising accepting a buyer pre-approval and locating a real estate listing. The method also includes accepting information related to an offer on the real estate listing and transmitting the offer and the pre-approval.

Another aspect of the present disclosure provides a real estate transaction system operable on a server, accessible by a network, comprising a buyer component for allowing a buyer to place offers on real estate, the buyer component capable of storing loan pre-approval for a buyer and a seller component for allowing a seller to respond to the offer.

Yet another aspect of the present disclosure provides computer program product, comprising a non-transitory computer-readable medium comprising code for accepting a buyer pre-approval, code for locating a real estate listing, code for accepting information related to an offer on the real estate listing, and code for transmitting said offer and said pre-approval.

A better understanding of the features and advantages of the present embodiments will be obtained by reference to the following detailed description of the invention and accompanying drawings, which set forth illustrative embodiments in which the principles of the invention are utilized.

### BRIEF DESCRIPTION OF THE DRAWINGS

The accompanying drawings are included to provide a further understanding of the present invention, and are incorporated in and constitute a part of this specification.

FIG. 1 is a flow chart demonstrating a current real estate transaction model.

FIG. 2 is a flow chart demonstrating another current real estate transaction model.

FIG. 3 is a flow chart demonstrating one embodiment of a real estate transaction model according to the present disclosure.

FIG. 4A and 4B are a series of screenshots demonstrating a sequence of steps used to place an offer according to one embodiment of the present disclosure.

FIG. 5A, 5B and 5C are a series of screenshots demonstrating a sequence of steps to manage a real estate transaction according to one embodiment of the present disclosure.

FIG. 6A and 6B are a series of screenshots demonstrating a sequence of steps to secure a loan pre-approval according to one embodiment of the present disclosure.

FIG. 7 is a screenshot demonstrating an interface for managing pre-approvals according to one embodiment of the present disclosure.

### DETAILED DESCRIPTION OF THE INVENTION

In the description that follows, numerous details are set forth in order to provide a thorough understanding of the invention. It will be appreciated by those skilled in the art that variations of these specific details are possible while still achieving the results of the invention. Well-known elements and processing steps are generally not described in detail in order to avoid unnecessarily obscuring the description of the invention.

Embodiments of the invention are described herein with reference to illustrations that are schematic illustrations of embodiments of the invention. As such, the actual size, components and features can be different, and variations from the components of the illustrations as a result, for example, of manufacturing techniques and/or tolerances and system configurations are expected. Embodiments of the invention should not be construed as limited to the particular components illustrated herein, but are to include deviations in system architecture and improvements. The regions, sections and components illustrated in the figures are schematic in nature and their devices and shapes are not intended to illustrate the precise shape of a feature of a device or device itself and are not intended to limit the scope of the invention. Furthermore, components described as being connected or connections may not be direct. Intervening components or connections may exist. Also, components may be shown as one unit, but may instead be a collection of components or units.

In the drawings accompanying the description that follows, reference numerals and legends (labels, text descriptions) may be used to identify elements. If legends are provided, they are intended merely as an aid to the reader, and should not in any way be interpreted as limiting.

Embodiments and configurations of the present disclosure describe a proposed portal or system, which will centralize the activities involved in placing an offer, for the use or purchase of real estate, into a single online portal. This means that a buyer can use one service, for example by logging on to one website or application (or mobile application), to both search properties and then directly place an offer through the website or mobile app, which would be transmitted to the listing agent in their specified desired manner (i.e. fax or email). In some embodiments, the portal or service would provide specific fields, such as names, addresses, offer prices or other specifics, to be populated by the buyer and may automatically use this buyer-provided information to generate an offer contract that would be received by the listing agent, resulting in a streamlined method for placing an offer on a home that adheres to all documents needed to place an offer. Certain fields will vary from one transaction to another, such as the offer amount made by the buyer. One advantage of such auto population may be that several offer forms can be populated without reentering this information.

Furthermore, the portal can include a document management system which will allow for uploading/importing and e-signing additional documents that may be necessary, as deemed by particular characteristics of a sale or particular listing agents/sellers. An example of this would be if a particular county requires additional contractual documentation put forth with an offer, the document can be uploaded and an e-signature can be placed on the document and include the document in the offer through the portal. In other embodiments, particular real estate deals may require other documentation such as environmental reports, proposed construction plans or permits, or addendums. These could all be transmitted through the portal. The listing agent and seller can then make a decision on the offer and if accepted, the transaction can open up escrow on the portal and continue managing the escrow contingency actions on the portal until all legal documents have been exchanged and signed. In some configurations, the portal may work directly or indirectly with escrow agencies to carry out the escrow process. In some embodiments, the portal will facilitate all document exchange and allow multiple users to participate in the transaction and escrow in order to enable a streamlined approach to the completion of the transaction.

In some configurations, the portal would have a search function that is capable of pulling up a property based on its particular listing information. The most common search fields include address, zip code, city, state and MLS number; however, other search fields may also be used. An MLS number could then pull up information placed on the MLS website for the listing that is being looked up. Upon searching the listing, the search results will display an appropriate match to the property in question, providing all the necessary details as listed on the MLS. The portal may pull up a map (i.e. google maps or other mapping feature) of the location of the property, ensuring that the property being searched is in the desired location sought after by the buyer.

In some configurations, buyers who need to get a pre-approval in order to become qualified may do so through the portal. In yet other configurations, this portal will serve to integrate and collect pre-approved buyers across various banks and lending brokerages to allow both tracking of these buyers by those entities, as well as provide the buyers the ability to execute a prospectively funded offer through the portal. For example, in one configuration, a loan officer may input their client's pre-approval into the portal, which in turn would allow their client or their client's agent to place an offer on their behalf. When an offer is placed through the portal, the loan officer may receive a notice, message or alert, that their pre-approval has been utilized in an offer, which would allow them to properly follow up with their client and ensure funding of the loan. In yet another example, according to one configuration, a loan officer may also extend a pre-approval of a client through the portal, which provides convenience for the loan officer, client and real estate agent as all this information would be automatically shared with the appropriate parties.

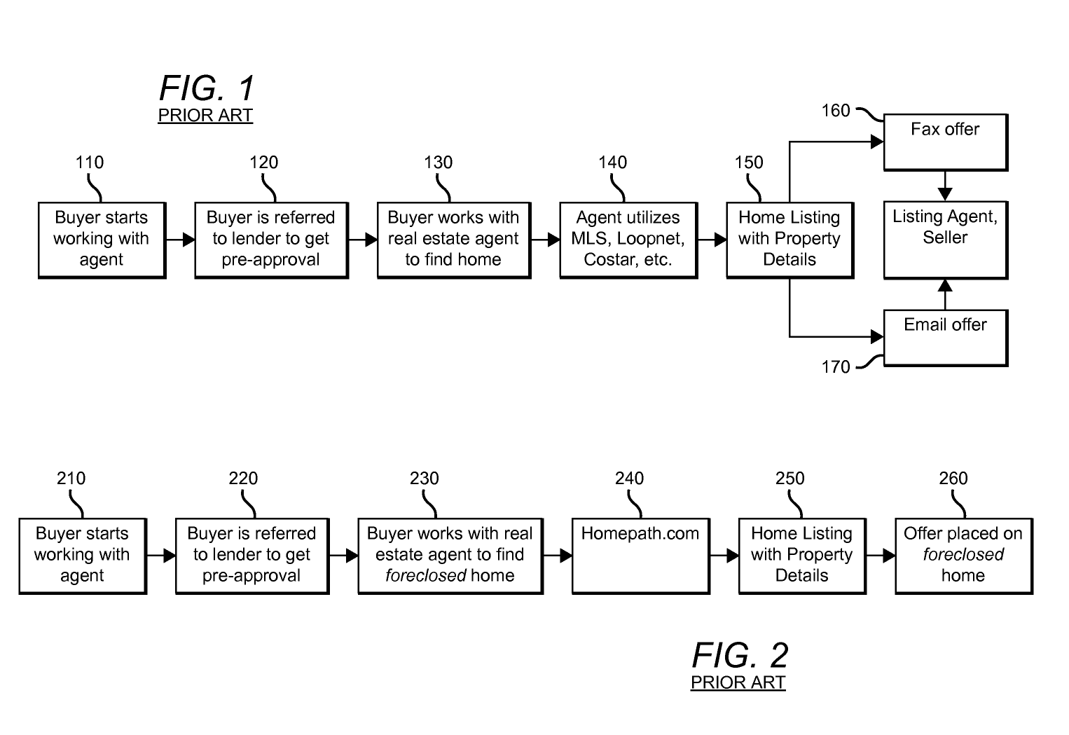

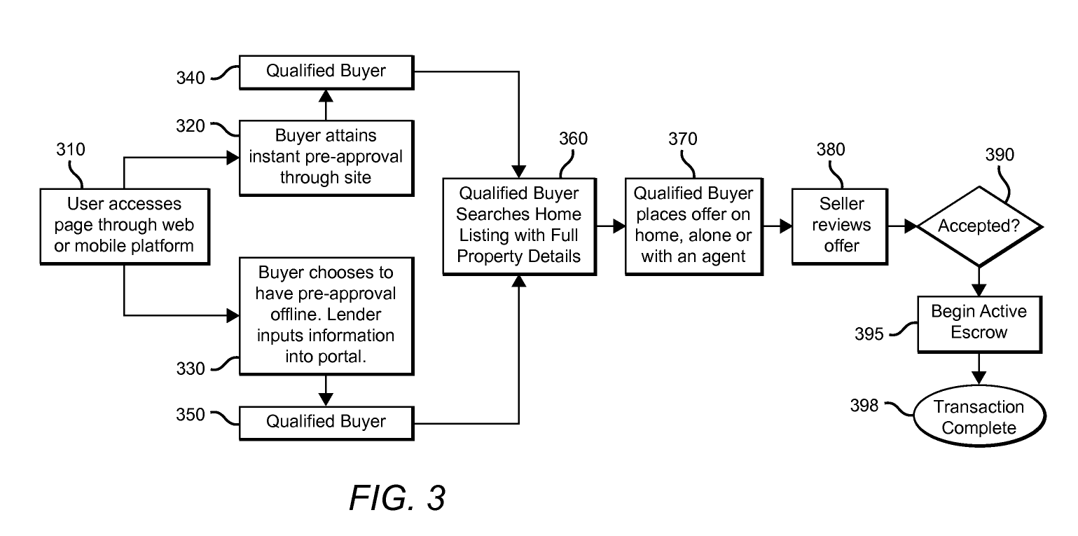

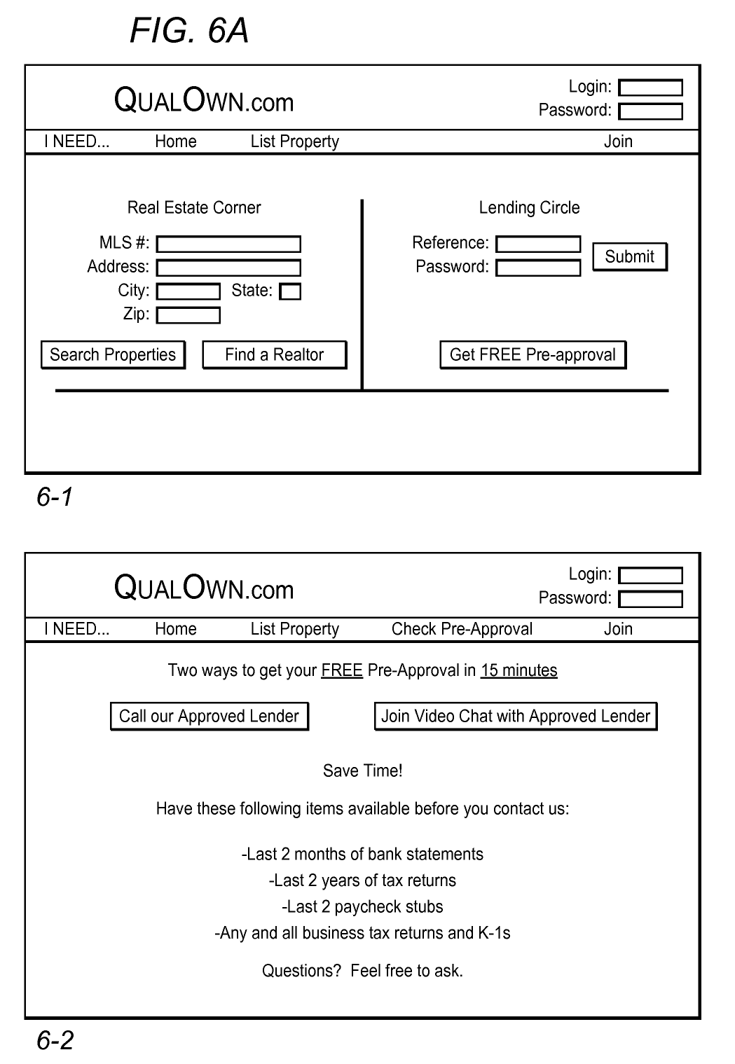

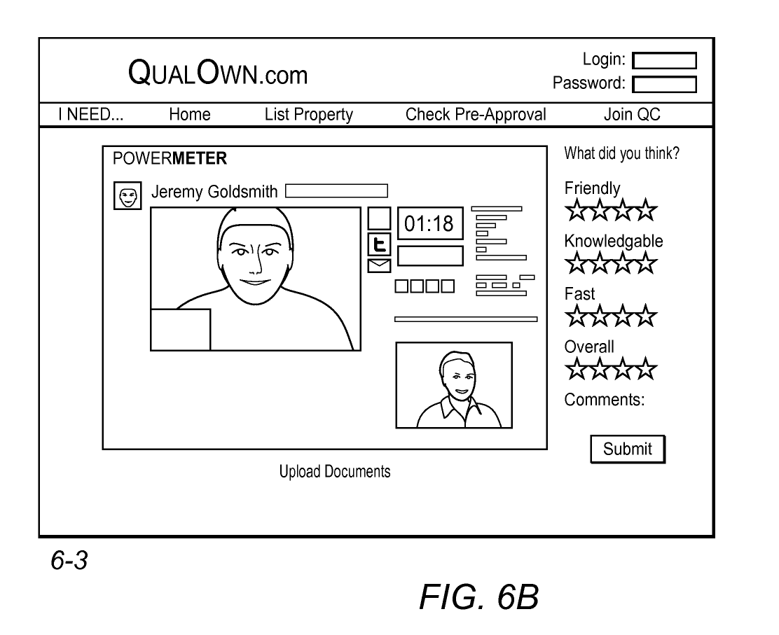

FIGS. 6A and 6B highlights the sequence of steps allowing a buyer to attain an instant pre-approval. FIG. 6-1 indicates the home page, where the buyer can click on a link requesting a pre-approval. FIG. 6-2 indicates the subsequent step, which allows the buyer to choose a method of attaining a pre-approval. In this step, the buyer can either choose to contact a lender, in a manner outside of the system, such as in person or via telephone to attain the pre-approval, or the buyer may choose to contact a lender through the system, such as by chat, voice chat, connect through a video chat, or any other correspondence option, as shown in FIG. 6-3. Both of these methods allow the buyer to utilize the portal to upload all relevant documents, expediting the process and allowing for a quicker qualification.

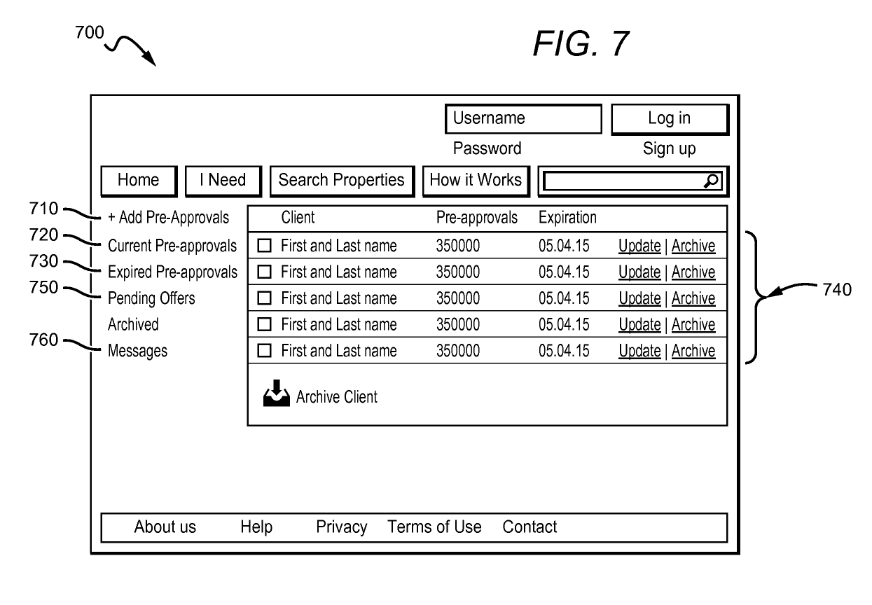

In some configurations, the portal will also store pre-approvals inputted by lenders as a database of pre-approvals. The pre-approval features, of one configuration of the system, can be utilized in a number of ways. For example, as discussed above, a buyer may use the portal to obtain the pre-approval. A realtor or seller may use the system to verify that a buyer has a pre-approval. Additionally, lenders may use the system as a database for all issued pre-approvals, whether the potential buyer is a current user of the portal or not. Thereby, rather than mailing letters to realtors or sellers, sellers may log into the system to verify pre-approval, regardless of the buyers participation in the portal. FIG. 7 shows one example of a portal dashboard 700 for lenders, where lenders can upload 710 and manage pre-approvals 740. As shown, the lender or lender's agent may add pre-approvals 710, view current 720 and expired pre-approvals 730, renew or extend pre-approvals 740, review pending offers 750, and send or receive messages 760.

In one embodiment, whereas a home buyer traditionally attains a pre-approval by connecting with a lender, the lender, after attaining proper paperwork, provides the home buyer with a pre-approval letter indicating the amount of financing the buyer qualifies for during a period of time designated by the lender. This portal allows for lenders to input this information onto the portal, rather than hand a letter to their client. This can serve to centralize the information for the lender, the buyer and any representatives of the buyer chooses to work with during the purchase process. In one situation, if the lender is unavailable and the buyer has misplaced the letter, rather than scrambling or having to go through the inconvenience of providing a new letter to the client, the lender can direct his/her client to the database on the portal. There a buyer can utilize the portal to view their pre-approval letter, whether they were previous portal users or not.

In some embodiments, the portal is accessed via a unique username and password. In other embodiments, the portal or particular letter may be accessed via a temporary access code or other feature. Creating such a database may allow for real estate agents and buyer representatives to have quicker access to an online database, which allows verifications of pre-approvals, allowing them to determine whether clients are qualified buyers. Traditionally, lenders draft a letter indicating the pre-approval qualifications and send that to a real estate agent or buyer representative. Embodiments of the service allow the process to be streamlined through this portal.

FIG. 3 depicts one exemplary workflow process of using a system or portal according to the present disclosure to attempt a real estate transaction. In step 310 a user accesses the system. Access to the system may be over a network or may be stored locally. In step 320, the buyer uses the system to obtain lender pre-approval, followed by becoming a qualified buyer in step 340. Alternately, if the user prefers, they may obtain pre-approval without the use of the system 330 and become deemed a qualified buyer 350. Next, the qualified buyer searches home listings and receives property details using the system 360. In some embodiments, the buyer may skip the qualification steps and begin at step 360. Home listing and property information may be stored locally, on servers that the system operates on or with, or may be dynamically accessed from other databases or services. Next, a qualified buyer may place an offer on a property utilizing the system 370. Offer placement may be done directly by the buyer or through a realtor also using the system. Next, a seller or seller's agent receives and reviews the offer via the system 380. The seller or seller's agent can then respond to the offer via the system. In some embodiments, the seller may receive alerts or messages any time they receive an offer or any time their listing or seller agent receives an offer on their property. If the offer is accepted 390, escrow can be initiated 395 and the sale (or lease) transaction completed 398.

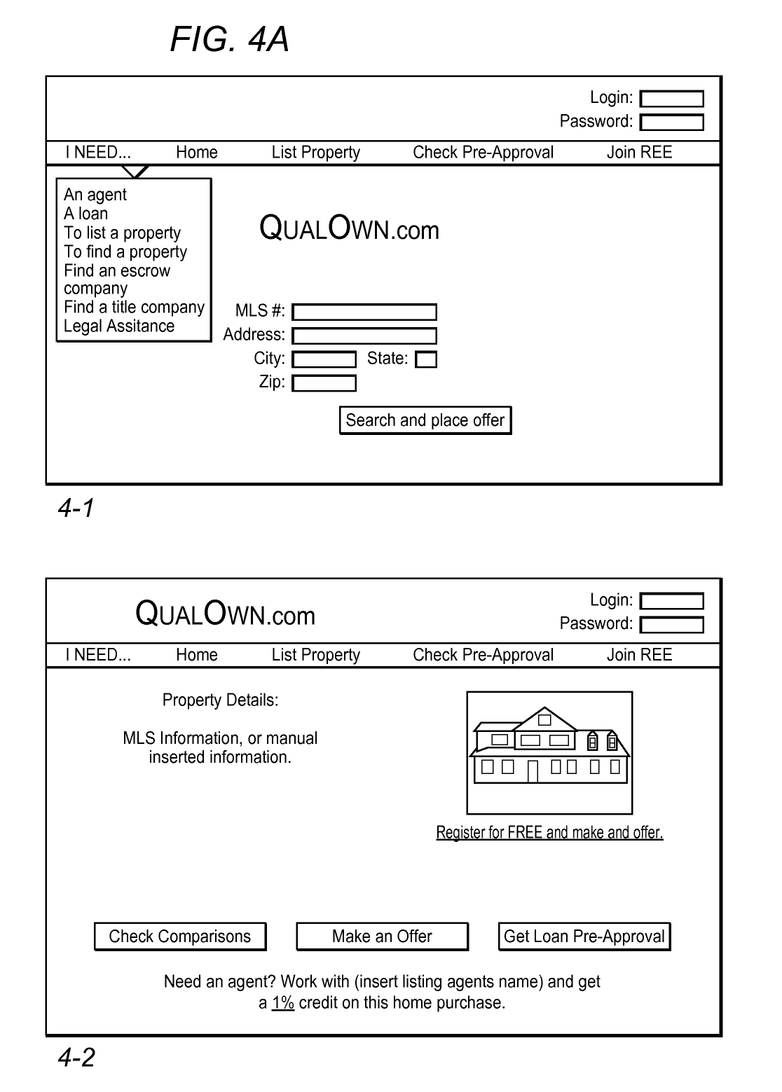

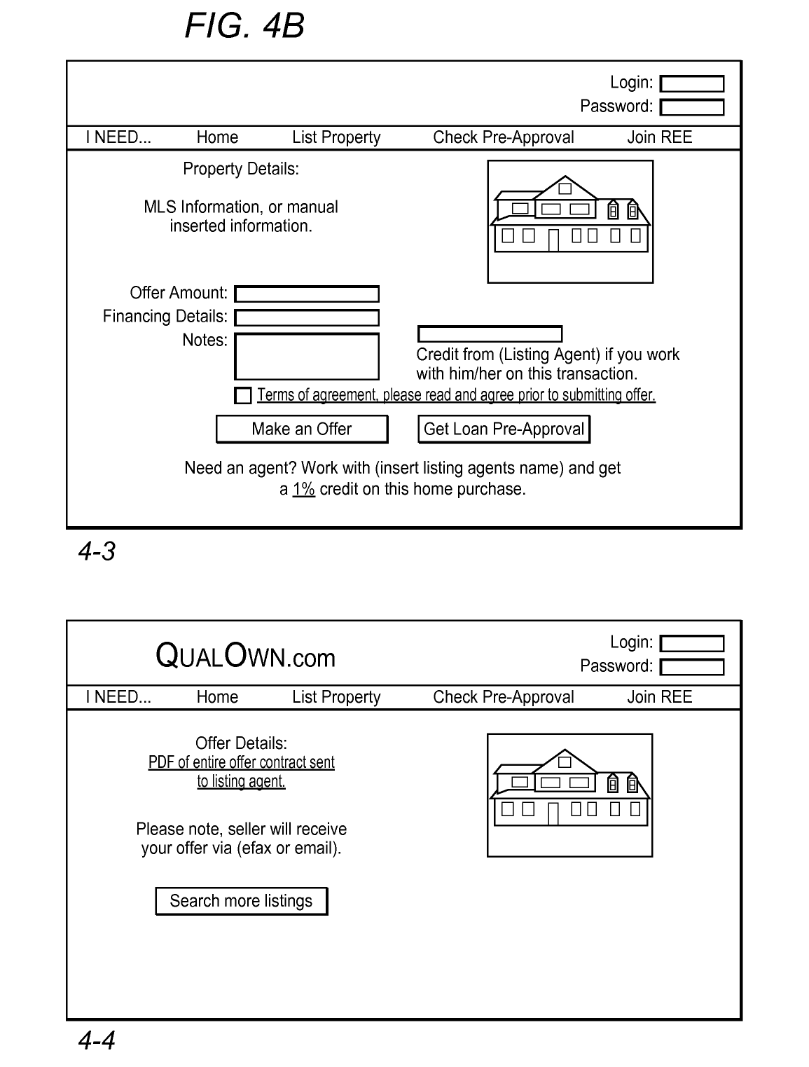

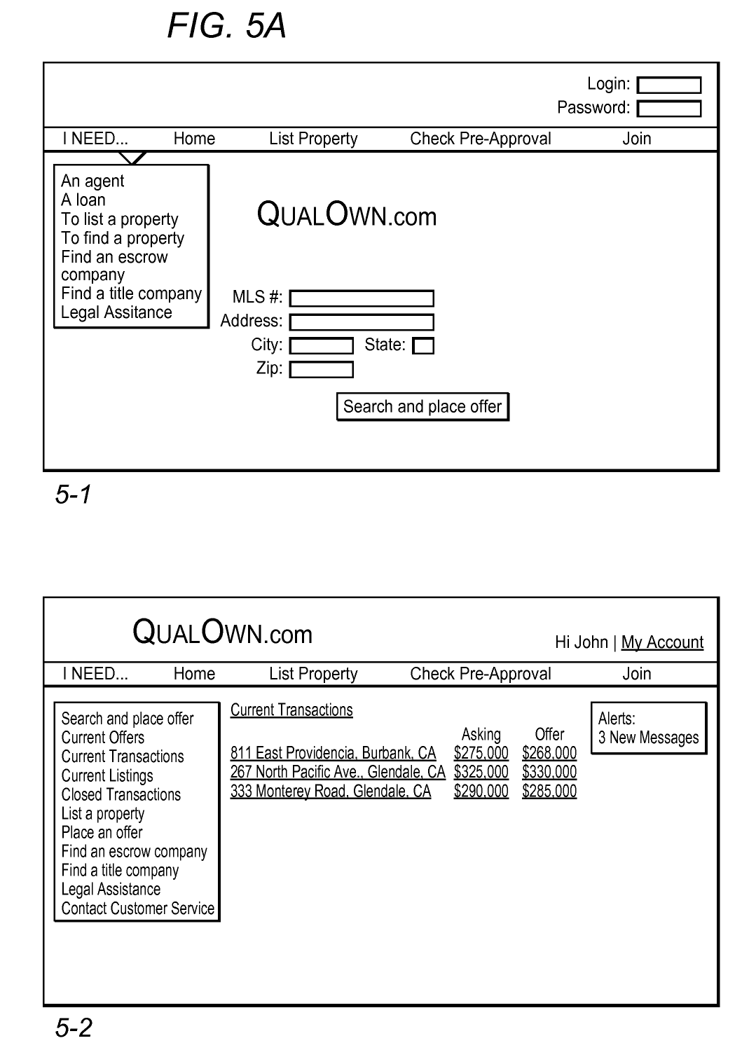

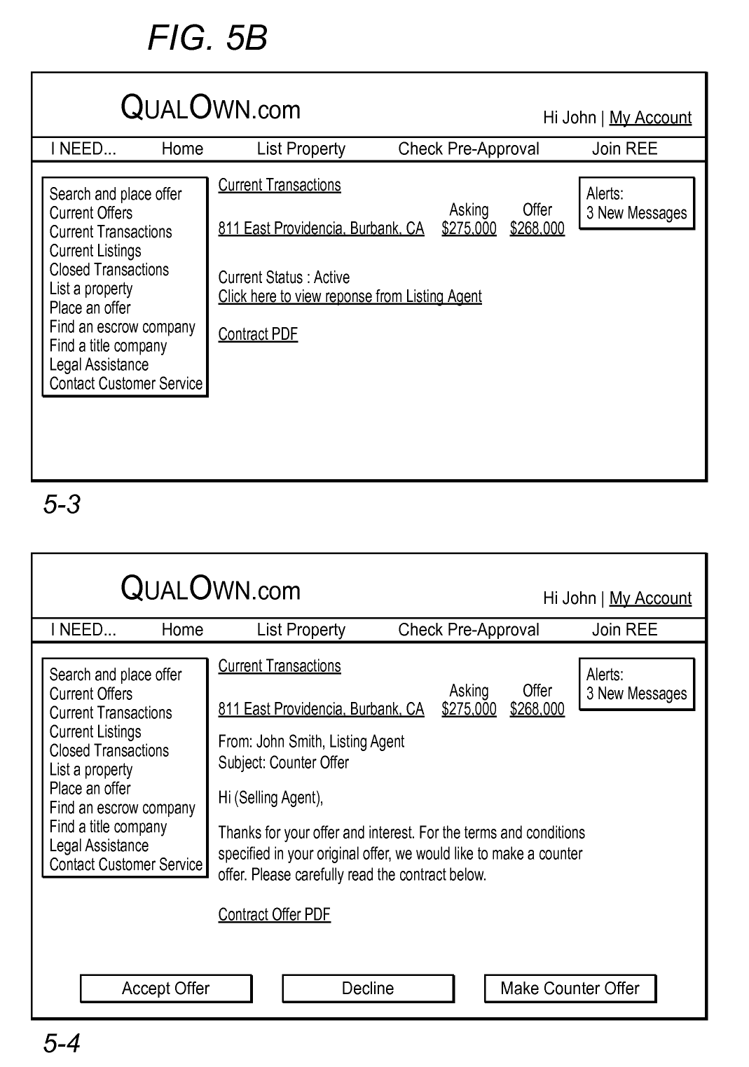

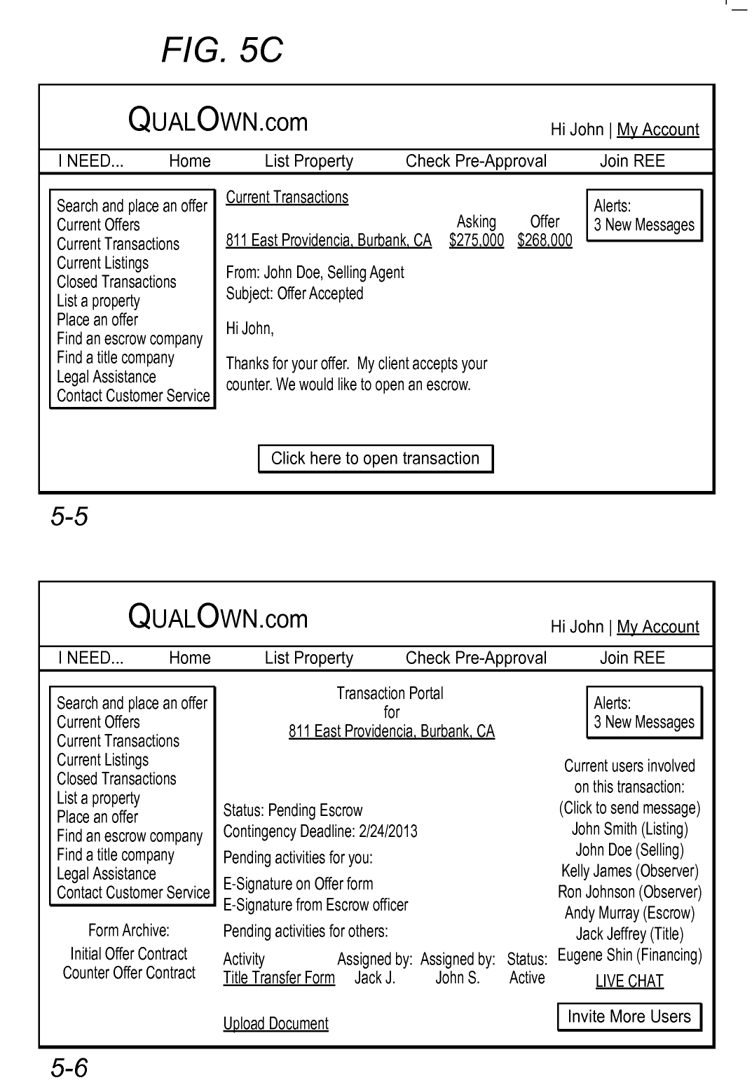

FIGS. 4A, 4B, 5A, 5B and 5C disclose exemplary steps or sequences to place offers or manage transactions, respectfully, using one embodiment of the system. In these exemplary figures, it is demonstrated how the process differentiates itself from the prior art systems, methods, companies and ideas. First, the present system may provide an instant pre-approval to a user (assuming they have not already been provided a pre-approval). Next the user is able to search for listings and attain details about the listing. The user then can directly input their offer on the portal, which would then be received by the listing agent. The listing agent then can respond to the offer on the system.

FIGS. 4A and 4B show an exemplary embodiment of a sequence of steps that are executed to place an offer in one configuration of the presently disclosed system. Though the figures show exemplary website interfaces and layouts, it should be understood that these are for illustration purposes and the layout or interface may differ. In the first step 4-1, a buyer may log onto the homepage. This log in may be done with a username and password, an access code, guest access, or merely by entering the required buyer information. Next in step 4-2, a buyer looks up or accesses properties or listings. This can be done in a variety of manners, such as by browsing a list or searching a variety of criteria or information. In an optional next step, not shown in the figures, a buyer can apply for or attain a pre-approval on the page. In some configurations the pre-approval process may be nearly instant, whereas in others it may be an extended application process. The buyer also has a choice to attain a pre-approval offline as well. If the user wants to utilize his or her own loan officer to attain a pre-approval, they may do so offline and then input the user's pre-approval into the portal (directly or by the loan officer), allowing access to the user to place offers on properties which require pre-approval. Once a buyer receives a pre-approval, they become a “Qualified Buyer,” which allows them to go beyond only searching and allows them to place offers on the home. In the next step 4-3, a buyer fills out the fields required after deciding to place an offer on the property previously selected. Lastly, in step 4-4, the Offer is sent to the listing agent or seller.

FIGS. 5A-5C show an exemplary embodiment of a sequence of steps that are executed to manage a transaction in one configuration of the presently disclosed system. In the first step 5-1, the Buyer, Seller or Lender accesses the system. This may be done by logging into an application, web page, mobile application, plug-in or other system access points. Next, in step 5-2, the Buyer, Seller, or Lender has access to their profile account presented, allowing the Buyer, Seller, or Lender to manage multiple transactions at the same time. Following this, in step 5-3, the Buyer, Seller, or Lender can click on a transaction or pre-approval in Step 5-2 to view further details. After viewing details, in steps 5-4 and 5-5, the Buyer, Seller, or Lender can click on a link that allows them to view messages. These messages may be system messages, or messages from parties within a transaction such as the opposing party or an agent. The Buyer, Seller, or Lender can exchange information, upload any necessary paperwork and utilize e-signatures or any other form of authorization to complete forms or paperwork. Next, in step 5-6, an open transaction is shown, this page is available after an offer has been accepted. This page shows how a Buyer and Seller, along with all relevant parties can participate in one portal to exchange information and documents necessary to complete a real estate transaction. The escrow process can be handled entirely through this portal if the parties wish to proceed in that manner after accepting a transaction. The parties can also choose not to continue on the portal, and close the rest of the transaction with the third party escrow company in the manner they wish.

While the foregoing written description of the invention enables one of ordinary skill to create and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

We claim:

1. A method facilitating real estate transactions through a portal, comprising:
accepting a buyer pre-approval;
locating a real estate listing;
accepting information related to an offer on said real estate listing; and
transmitting said offer and said pre-approval.

2. The method of claim 1, further comprising accepting a user login.

3. The method of claim 2, wherein said user is one of a buyer, buyer's agent, a lender or a seller.

4. The method of claim 1, further comprising accepting a response to said offer.

5. The method of claim 1, further comprising requesting lender pre-approval.

6. The method of claim 1, further comprising allowing management of a plurality of said pre-approvals.

7. The method of claim 3, further comprising allowing interaction between a plurality of users.

8. The method of claim 7, wherein said interaction includes at least one of exchanging files, exchanging documents, exchanging messages or submitting e-signatures.

9. The method of claim 1, further comprising accepting file uploads.

10. The method of claim 1, further comprising accepting e-signatures.

11. The method of claim 1, further comprising repopulating said information in other fields.

12. The method of claim 11, in which said information is repopulated in a subsequent offer.

13. A real estate transaction system operable on a server, accessible by a network, comprising:
a buyer component for allowing a buyer to place offers on real estate, the buyer component capable of storing loan pre-approval for a buyer; and
a seller component for allowing a seller to respond to said offer.

14. The system of claim 13, further comprising a lender component capable of accepting lender pre-approvals.

15. The system of claim 14, in which the lender component is also capable of managing existing lender pre-approvals.

16. The system of claim 15, in which managing includes creation, removal and/or modification.

17. The system of claim 13, further comprising an agent component capable of performing the functions of the buyer component on behalf of a plurality of buyers.

18. The system of claim 13, further comprising a message center component capable of displaying messages from the system and/or other components.

19. The system of claim 13, further comprising a search component, accessible by other components, capable of searching a database of listings.

20. The system of claim 13, further comprising lender and agent components, in which all of said components are capable of uploading files, said components also capable of providing e-signatures.

21. A computer program product, comprising:
a non-transitory computer-readable medium comprising:
code for accepting a buyer pre-approval;
code for locating a real estate listing;
code for accepting information related to an offer on said real estate listing; and
code for transmitting said offer and said pre-approval.

22. The computer program product of claim 21, further comprising code for accepting a user login.

23. The computer program product of claim 22, wherein said user is one of a buyer, agent, a lender or a seller.

24. The computer program product of claim 21, further comprising code for accepting a response to said offer.

25. The computer program product of claim 21, further comprising code for requesting lender pre-approval.

26. The computer program product of claim 21, further comprising code for allowing management of a plurality of said pre-approvals.

27. The computer program product of claim 22, further comprising code for allowing interaction between a plurality of users.

28. The computer program product of claim 27, wherein said interaction includes at least one of exchanging files, exchanging documents, exchanging messages or submitting e-signatures.

29. The computer program product of claim 21, further comprising code for accepting file uploads.

30. The computer program product of claim 21, further comprising code for accepting e-signatures.

31. The computer program product of claim 21, further comprising code for repopulating said information in other fields.

32. The computer program product of claim 31, in which said information is repopulated in a subsequent offer.
